(19) United States
(12) Patent Application Publication
(10) Pub. No.: US 2025/0043699 A1
(43) Pub. Date: Feb. 6, 2025

(54) MATING ASSEMBLY FOR ANNULAR ENGINE COMPONENTS

(71) Applicant: GENERAL ELECTRIC COMPANY, Schenectady, NY (US)

(72) Inventor: Kenneth R. Willett, Mukilteo, WA (US)

(21) Appl. No.: 17/956,946

(22) Filed: Sep. 30, 2022

(51) Int. Cl. F01D 25/24; F01D 9/04

(52) U.S. Cl. CPC F01D 25/243; F01D 9/04; F01D 25/246; F05D 2220/323; F05D 2230/60; F05D 2240/14

(57) ABSTRACT

An apparatus for a turbine engine of a mating assembly with a casing and a shroud circumscribing the casing. One of the casing or shroud including at least one flange defining a v-groove. The other of the casing or shroud including an annular protrusion defining a v-blade received in the v-groove when the casing is mated with the shroud.

### TECHNICAL FIELD

This disclosure generally relates to a turbine engine, and more specifically, to mating annular engine components in the turbine engine.

### BACKGROUND

An engine casing is formed with an annular flange, which can abut another annular flange formed on a nacelle. Typically, a plurality of spaced bores are formed around the circumference of each flange. The engine casing is then mounted to the nacelle by aligning the bores of the two flanges and then inserting bolts therebetween which are secured by nuts.

Positioning the engine flange in proper alignment with the exhaust nozzle flange can be time consuming. Such flanges have planar abutting surfaces and it is difficult and time consuming to align the flanges vertically and circumferentially when the engine is being lifted into place against the exhaust nozzle.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a perspective view of an aircraft with two turbine engines.

FIG. 2 is a cross-sectional view of one of the two turbine engines with a nacelle according to an aspect of the disclosure herein.

FIG. 3 is a schematic front view of the aircraft from FIG. 1 with two engines, one of the engines with the nacelle in an open position according to an aspect of the disclosure herein.

FIG. 4 is an enlarged cross-sectional view taken along line IV-IV of FIG. 2 showing a fan casing.

FIG. 5 is an enlarged cross-sectional view of a portion of the fan casing of FIG. 4 with a portion of the nacelle abutting a pair of flanges on the fan casing and illustrating a mating assembly according to an aspect of the disclosure herein.

FIG. 6 is an enlarged schematic of the mating assembly from FIG. 5 taken along line VI-VI.

FIG. 7 is a schematic cross-sectional view of a first annular component and a second annular component concentric with respect to each other and circumferentially aligned with a mating assembly according to another aspect of the disclosure herein.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

Aspects of the disclosure generally relate to a mating assembly between annular components, one circumscribing at least a portion of the other. For purposes of illustration, the present disclosure will be described with respect to the nacelle and fan casing for an aircraft gas turbine engine. It will be understood, however, that aspects of the disclosure described herein including circumferential alignment of flanges, are not so limited and may have general applicability within an engine, as well as in non-aircraft applications, such as other mobile applications and non-mobile industrial, commercial, and residential applications.

Alignment features between engine shrouds, such as the nacelle for a turbine engine, and annular engine casings can include existing struts, ducts, and other components located on an exterior of the engine casing. In the absence of existing structures, it is beneficial to provide an alignment feature that is part of the casing and/or shroud.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first,” “second,” and “third” can be used interchangeably to distinguish one component from another and are not intended to signify location or importance of the individual components.

The terms “forward” and “aft” as may be used herein, refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The singular forms “a”, “an”, and “the” include plural references unless the context clearly dictates otherwise.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate structural elements between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

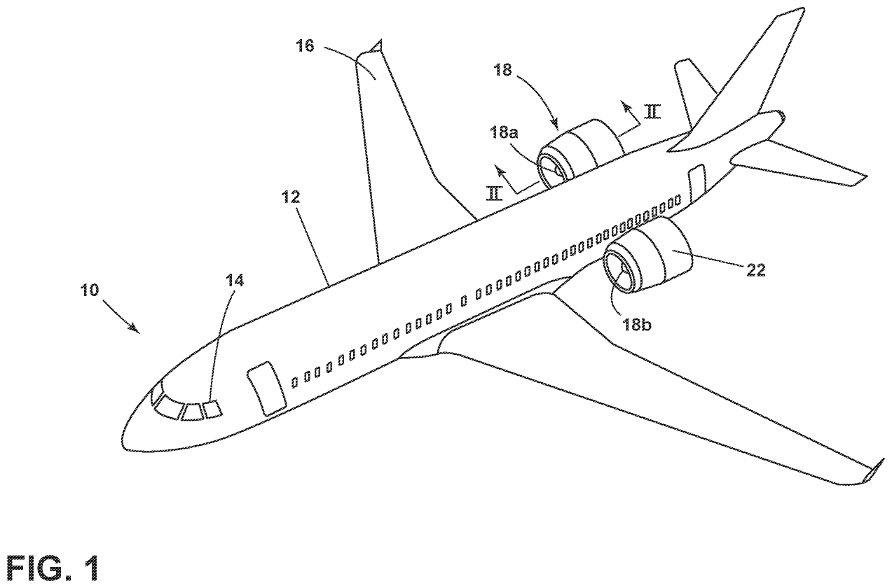

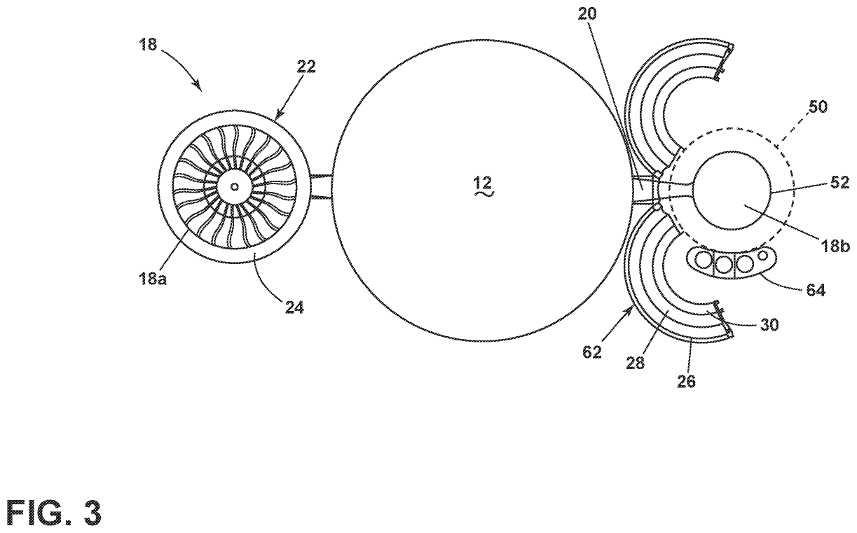

FIG. 1 is a perspective view of an aircraft 10. The aircraft 10 includes a fuselage 12, a cockpit 14 positioned in the fuselage 12, and wing assemblies 16 extending outward from the fuselage 12. The aircraft 10 includes at least one gas turbine engine 18 mounted to the fuselage 12 via a pylon 20 (FIG. 3). The at least one gas turbine engine 18 is illustrated as a first and a second gas turbine engine 18a, 18b with both covered by an annular shroud, by way of non-limiting example a nacelle 22. While two gas turbine engines 18a, 18b have been illustrated, it will be understood that any number of gas turbine engines 18 including gas turbine engines on the wing assemblies 16, or even a single gas turbine engine mounted onto the fuselage 12 is contemplated.

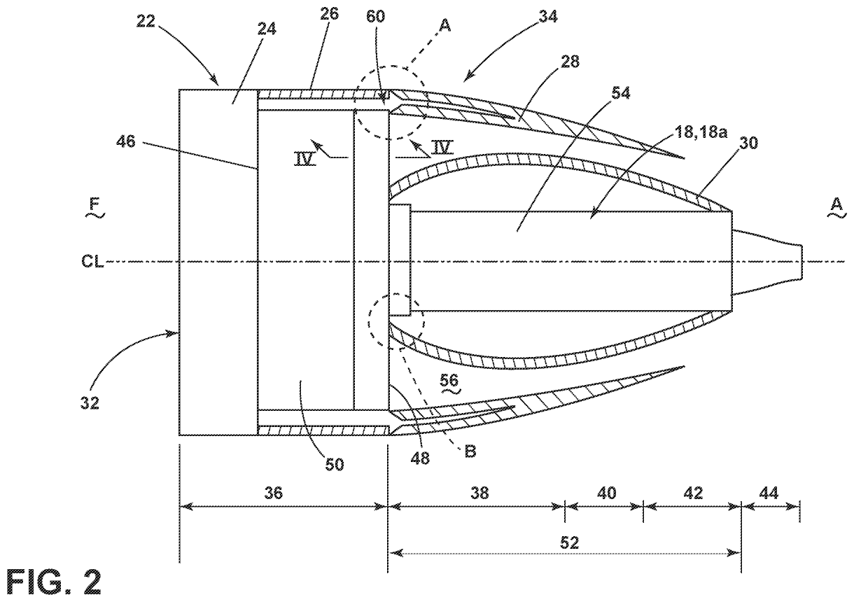

FIG. 2 is a cross-sectional view of a schematic of the nacelle 22 and the gas turbine engine 18a. The nacelle 22 surrounds and protects the gas turbine engine 18a. The gas turbine engine 18a has a generally longitudinally extending axis or engine centerline (denoted “CL”) extending forward (denoted “F”) to aft (denoted “A”). The nacelle 22 can include an inlet cowl 24 surrounding and defining an inlet 32 of the gas turbine engine 18a. A cowling assembly 34 can include removable or movable parts of the nacelle 22 including a fan cowl 26, an exhaust duct cowl 28 and an engine cowl 30. The cowling assembly 34 at least partially defines the nacelle 22. The fan cowl 26 provides access to a fan section 36 of the gas turbine engine 18a. The exhaust duct cowl 28 defines at least a portion of a bypass duct 56 for the gas turbine engine 18a. The engine cowl 30 provides access to a core 52 of the gas turbine engine 18a. The core 52 can include a compressor section 38, a combustion section 40, and a turbine section 42. The fan section 36, the compressor section 38, the combustion section 40, the turbine section 42, and an exhaust section 44 can be arranged in a downstream serial flow relationship along the engine centerline CL.

A fan casing 50 extends axially between a first end 46 and a second end 48 aft the first end 46 and surrounds all of the rotating fan parts of the fan section 36. A core casing 54 similarly surrounds all of the rotating parts of the engine core 52. The core casing 54 can be coupled with the fan casing 50.

A mating assembly 60 can mate the exhaust duct cowl 28 with the fan casing 50 at a first location (denoted “A”) and the engine cowl 30 with the core casing 54 at a second location (denoted “B”). While an aircraft 10 with a gas turbine engine 18 has been illustrated, it is contemplated that the mating assembly 60 can be utilized in any annular shroud/casing arrangement, and that the gas turbine engine 18 is one implementation.

FIG. 3 is a front view of the gas turbine engines 18a, 18b from FIG. 1 with the second gas turbine engine 18b schematically represented with the cowling assembly 34 open and hingedly coupled to the pylon 20. The inlet cowl 24 can be separate or part of the cowling assembly 34. It can more clearly be seen that those parts of the gas turbine engine 18 which are mounted outside of the fan casing 50 and core casing 54, by way of non-limiting example, an accessory gear box 64 mounted to the fan casing 50, are accessible with the cowling assembly 62. In operation, opening and closing the cowling assembly 34 utilizes axial and circumferential alignment between portions of the cowling assembly 34 that meets and mates with portions of the fan casing 50 and/or the core casing 54.

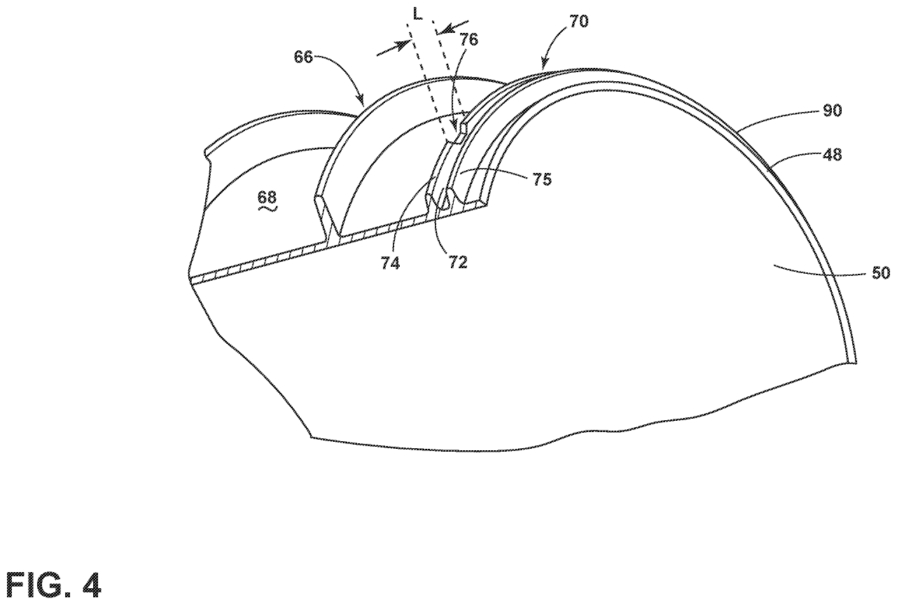

FIG. 4 depicts an enlarged cross-sectional view taken along line IV-IV of FIG. 2, showing the fan casing 50. At least one circumferential wall 66 extends radially from an exterior 68 of the fan casing 50. The at least one circumferential wall 66 can be multiple circumferential walls 66 axially spaced from each other wherein two of the multiple circumferential walls define a pair of flanges 70 located proximate the second end 48 of the fan casing 50. The pair of flanges 70 can define a v-groove 72. At least one flange of the pair of flanges 70 can be an angled flange 74 whereas the other of the pair of flanges 70 can be an angled or straight flange 75 as illustrated. At least one keyway 76 can be provided in at least one of the pair of flanges 70, by way of non-limiting example in the angled flange 74 as illustrated. The at least one keyway 76 can extend circumferentially a length (denoted “L”). The length L is large enough to accommodate necessary circumferential shifts during operation and small enough to ensure circumferential alignment.

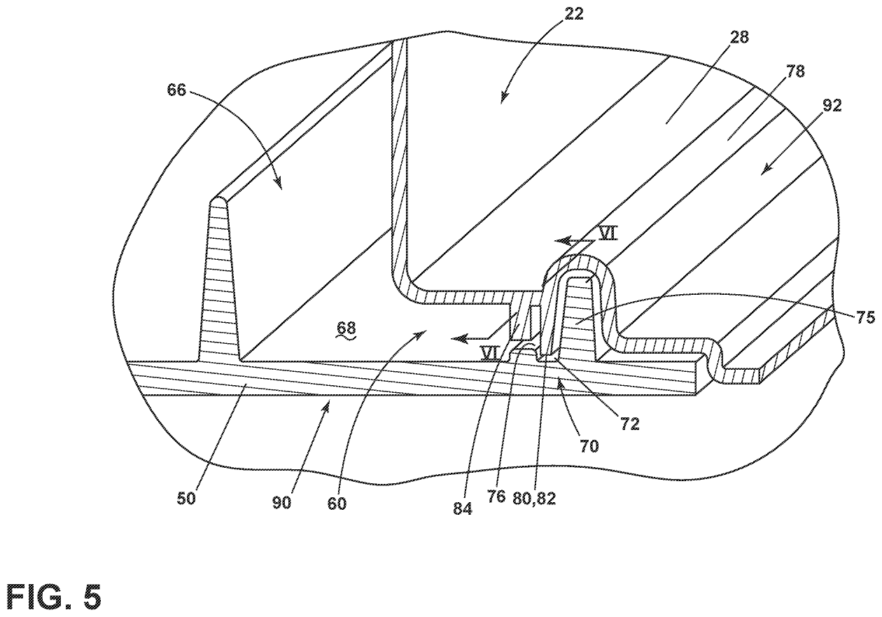

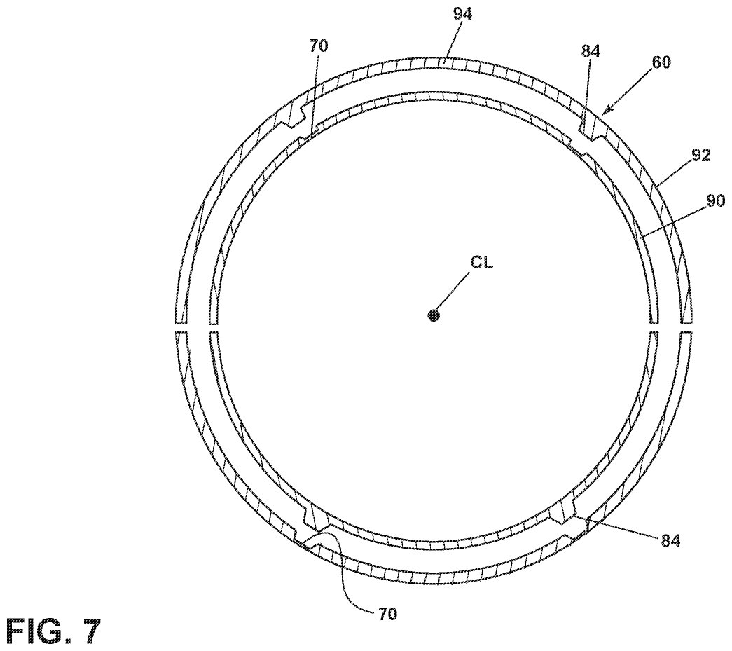

FIG. 5 shows the enlarged portion of the fan casing 50 of FIG. 4 with a portion of the nacelle 22, by way of non-limiting example the exhaust duct cowl 28, abutting the pair of flanges 70. The exhaust duct cowl 28 can include a bend portion 78 defining an annular protrusion 80 received in the v-groove 72 and defining a v-blade 82. The annular protrusion 80 can define an arc concentric with and abutting at least one flange of the pair of flanges, by way of non-limiting example the straight flange 75. At least one key 84 can extend radially inward from exhaust duct cowl 28 just forward of the v-blade 82 and be sized to be received in the at least one keyway 76. In one example, the at least one key 84 and the v-blade 82 extend from the second annular component 92, the exhaust duct cowl 28 as illustrated. It is further contemplated that the at least one key 84 is located in the first or second annular component 90, 92, for example the fan casing 50 (FIG. 7) and the v-blade 82 is located in the other of the first or second annular component 90, 92, for example the exhaust duct cowl 28.

It should be understood that while the fan casing 50 is referred to herein as the first annular component 90 having the v-groove 72 with the at least one keyway 76 and the exhaust duct cowl 28 is referred to herein as the second annular component 92 including the v-blade 82 and the at least one key 84, the first and second annular components 90, 92 can be any two components at least partially circumscribing each other and in need of circumferential alignment. Together, the first or second annular component 90, 92 with the at least one keyway 76 and other of the first or second annular component 90, 92 with the at least one key 84 define the mating assembly 60.

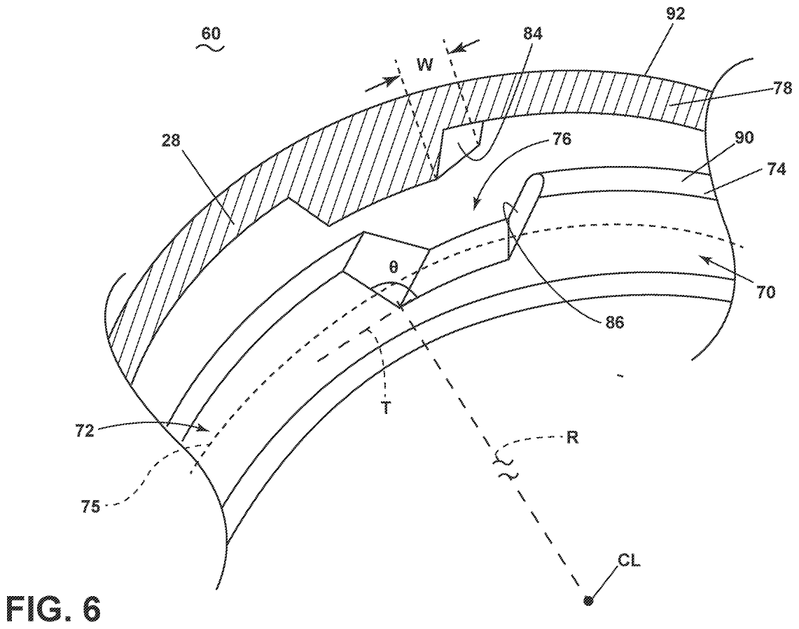

FIG. 6 is an enlarged schematic of the mating assembly 60 taken along line VI-VI of FIG. 5. The straight flange 75 of the pair of flanges 70 is illustrated in dashed line for clarity. The keyway 76 can include sloped walls 86 angled at a key angle θ greater than or equal to ninety degrees with respect to a tangent line (denoted “T”) perpendicular to a radial direction (denoted “R”) measured from the engine centerline CL (FIG. 2). This angle permits the key 84 of the second annular component 92 to engage off-perpendicular. Additionally, the key angle θ can be determined by an amount of engagement between the first and second annular components 90, 92. The amount of engagement defined as when the cowling assembly 34, and in turn the v-blade 82 (FIG. 6) is closed onto the v-groove 72. The key angle θ may differ from side to side so as to allow free engagement along with the length L (FIG. 4). The key angle θ is less than 170° and greater than 90°. In some implementations, the key angle is between 110° and 140°. A width (denoted “W”) of the key 84 is determined by the amount of circumferential load the sloped walls 86 would be required to carry with respect to the second annular component 92 in which the key 84 is located. It should be understood that the length L and the width W depend on the circumference of the first and second annular components 90, 92.

FIG. 7 illustrates exemplary concentric first and second annular components 90, 92 according to an aspect of the disclosure herein. The first annular component 90 is circumscribed by the second annular component 92. The first and second annular components 90, 92 can be arced panels 94 defining at least an arc circumscribing half or less than half of a full circumference of the first or second annular components 90, 92. Further, either the first or second annular component 90, 92 can include the at least one keyway 76 while the other of the first or second annular component 90, 92 includes the at least one key 84. To ensure circumferential alignment, a plurality, by way of non-limiting example, four, mating assemblies 60 are provided. It should be understood that the first and second annular components 90, 92 of FIG. 7 are representative of any of the annular components described herein. Further, the at least one keyway 76 can be multiple keyways 76 all or some of which are located in one or the other of the first and second annular components 90, 92. Likewise, the corresponding key 84 can be multiple keys 84 all of or some of which are located in one or the other of the first and second annular components 90, 92.

Benefits associated with the disclosure discussed herein include providing circumferentially alignment for mating annular components in an engine without reliance on other engine parts. Additionally, the mating assembly provides for less parts, an elimination of bolts and nuts, for example. Elimination of parts results in weight decrease as well. The time for assembly and disassembly is also reduced providing for more efficient and easier maintenance.

It should be understood that any combination of the geometry related to the orientation of the first and second annular components to each other is contemplated. The varying aspects of the disclosure discussed herein are for illustrative purposes and not meant to be limiting.

It should be appreciated that application of the disclosed design is not limited to turbine engines with fan and booster sections, but is applicable to turbojets and turbo engines as well.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects are provided by the subject matter of the following clauses:

A turbine engine comprising a core having a compressor section, a combustion section and a turbine section in axial flow arrangement and defining an axially extending engine centerline; a nacelle circumscribing at least a portion of the core; at least one of the core or the nacelle comprising a first annular component and a second annular component, the first annular component and the second annular component concentrically arranged; the first annular component comprising one of a v-groove or a v-blade and the second annular component comprising the other of the v-groove or the v-blade, wherein the v-blade is received in the v-groove; at least one circumferential wall extending from one of the first annular component or the second annular component and defining at least a portion of the v-groove, the at least one circumferential wall including at least one keyway; at least one key extending from the other of the first annular component or the second annular component; and one of the first and second annular components circumferentially surrounding the other of the first and second annular components, and having one of the at least one key or the at least one keyway, mate with the other of the at least one key or the at least one keyway to circumferentially align the first and second annular components with respect to each other.

The turbine engine of any preceding clause wherein the first annular component is the nacelle.

The turbine engine of any preceding clause wherein the nacelle comprises an exhaust duct cowl.

The turbine engine of any preceding clause wherein the v-blade is an annular protrusion formed on the exhaust duct cowl.

The turbine engine of any preceding clause wherein the at least one key extends radially from the exhaust duct cowl forward of the v-blade.

The turbine engine of any preceding clause wherein the second annular component is a fan casing.

The turbine engine of any preceding clause wherein the fan casing comprises a pair of flanges.

The turbine engine of any preceding clause wherein the v-groove is defined by the pair of flanges.

The turbine engine of any preceding clause wherein the pair of flanges includes an angled flange.

The turbine engine of any preceding clause wherein the at least one keyway is formed in the angled flange.

The turbine engine of any preceding clause wherein the first annular component is an engine cowl.

The turbine engine of any preceding clause wherein the second annular component is a core casing having at least a portion circumscribed by the engine cowl.

A mating assembly for mating annular components in a turbine engine, the mating assembly comprising a casing; a shroud circumscribing at least a portion of the casing; one of the casing or the shroud extending axially between a first end and a second end, having at least one flange located at the second end and at least one keyway provided in the at least one flange; the other of the casing or the shroud having an annular protrusion extending therefrom and defining at least an arc concentric with and abutting the at least one flange; and at least one key axially spaced from the annular protrusion and received in the at least one keyway to circumferentially align the casing and the shroud with respect to each other.

The mating assembly of any preceding clause wherein the at least one flange is a pair of flanges.

The mating assembly of any preceding clause wherein the pair of flanges define a v-groove.

The mating assembly of any preceding clause wherein one of the pair of flanges is an angled flange and the at least one keyway is formed in the angled flange.

The mating assembly of any preceding clause wherein the annular protrusion defines a v-blade received in the v-groove.

The mating assembly of any preceding clause wherein the at least one key extends radially from the casing or the shroud with the v-blade.

The mating assembly of any preceding clause wherein the casing is a fan casing and the shroud is a nacelle concentric about at least a portion of the fan casing.

The mating assembly of any preceding clause wherein the casing is a core casing and the shroud is an engine cowl concentric about at least a portion of the core casing.

1. A turbine engine comprising:
a core having a compressor section, a combustion section and a turbine section in axial flow arrangement and defining an axially extending engine centerline;
a nacelle circumscribing at least a portion of the core;
at least one of the core or the nacelle comprising a first annular component and a second annular component, the first annular component and the second annular component concentrically arranged;
the first annular component comprising one of a v-groove or a v-blade and the second annular component comprising the other of the v-groove or the v-blade, wherein the v-blade is received in the v-groove;
at least one circumferential wall extending from one of the first annular component or the second annular component and defining at least a portion of the v-groove, the at least one circumferential wall including at least one keyway;
at least one key extending from the other of the first annular component or the second annular component; and
one of the first and second annular components circumferentially surrounding the other of the first and second annular components, and having one of the at least one key or the at least one keyway, mate with the other of the at least one key or the at least one keyway to circumferentially align the first and second annular components with respect to each other.

2. The turbine engine of claim 1 wherein the first annular component is the nacelle.

3. The turbine engine of claim 2 wherein the nacelle comprises an exhaust duct cowl.

4. The turbine engine of claim 3 wherein the v-blade is an annular protrusion formed on the exhaust duct cowl.

5. The turbine engine of claim 4 wherein the at least one key extends radially from the exhaust duct cowl forward of the v-blade.

6. The turbine engine of claim 1 wherein the second annular component is a fan casing.

7. The turbine engine of claim 6 wherein the fan casing comprises a pair of flanges.

8. The turbine engine of claim 7 wherein the v-groove is defined by the pair of flanges.

9. The turbine engine of claim 8 wherein the pair of flanges includes an angled flange.

10. The turbine engine of claim 9 wherein the at least one keyway is formed in the angled flange.

11. The turbine engine of claim 1 wherein the first annular component is an engine cowl.

12. The turbine engine of claim 11 wherein the second annular component is a core casing having at least a portion circumscribed by the engine cowl.

13. A mating assembly for mating annular components in a turbine engine, the mating assembly comprising:
a casing;
a shroud circumscribing at least a portion of the casing;
one of the casing or the shroud extending axially between a first end and a second end, having at least one flange located at the second end and at least one keyway provided in the at least one flange;
the other of the casing or the shroud having an annular protrusion extending therefrom and defining at least an arc concentric with and abutting the at least one flange; and
at least one key axially spaced from the annular protrusion and received in the at least one keyway to circumferentially align the casing and the shroud with respect to each other.

14. The mating assembly of claim 13 wherein the at least one flange is a pair of flanges.

15. The mating assembly of claim 14 wherein the pair of flanges define a v-groove.

16. The mating assembly of claim 15 wherein one of the pair of flanges is an angled flange and the at least one keyway is formed in the angled flange.

17. The mating assembly of claim 15 wherein the annular protrusion defines a v-blade received in the v-groove.

18. The mating assembly of claim 17 wherein the at least one key extends radially from the casing or the shroud with the v-blade.

19. The mating assembly of claim 13 wherein the casing is a fan casing and the shroud is a nacelle concentric about at least a portion of the fan casing.

20. The mating assembly of claim 13 wherein the casing is a core casing and the shroud is an engine cowl concentric about at least a portion of the core casing.
